(19) United States
(12) Patent Application Publication
(10) Pub. No.: US 2003/0061596 A1
(43) Pub. Date: Mar. 27, 2003

(54) Exposure apparatus, method of controlling same, and method of manufacturing devices

(75) Inventor: Toshihiko Motoki, Tochigi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/247,293

(22) Filed: Sep. 20, 2002

(30) Foreign Application Priority Data
Sep. 25, 2001 (JP) 2001-291853

(51) Int. Cl. G06F 17/50

(52) U.S. Cl. 716/21

(57) ABSTRACT

The time needed to set parameters in an exposure apparatus can be shortened by providing the apparatus with a parameter editing system having a function through which at least two parameters are defined by a common expression in a parameter setting area displayed on an editing screen for setting the parameters.

### FIELD OF THE INVENTION

This invention relates to an exposure apparatus, a method of controlling the exposure apparatus and a method of manufacturing devices using the exposure apparatus. More particularly, the invention relates to an exposure apparatus that operates based upon parameters, a method of controlling the exposure apparatus, and a method of manufacturing semiconductor devices by the exposure apparatus controlled by the control method.

### BACKGROUND OF THE INVENTION

Today's information-oriented society has undergone remarkable development owing to high-density integration of semiconductor devices. One of the most important techniques for the high-density integration of semiconductor devices, is device miniaturization. The device miniaturization employs an exposure apparatus in which a circuit pattern that has been formed on a reticle or the like is printed on a substrate coated with a photosensitive material (resist). The exposure apparatus carries out exposure in accordance with three types of control parameter sets, namely (1) a parameter set (job parameter set) for each exposure process, which is referred to as a “job”, (2) a parameter set (reticle parameter set) referred to as a “reticle file”, and (3) a parameter set (system parameter set) referred to as a “system file”.

These parameter sets are configured and edited using a parameter-set editing function referred to as an “editor”.

The job is a parameter set which, for each exposure process, includes parameters relating to various measurement sequences and parameters such as amount of exposure and various offsets. The values of these parameters can be changed to suitable values at any time. Since this job parameter set exists for each exposure process, several thousand to several tens of thousands of parameters are stored for one exposure apparatus. Ordinarily, there are about 1000 parameters per job (i.e., per job parameter set).

The reticle file is a parameter set that includes reticle-specific parameters. The number of reticle files prepared is equivalent to the number of reticles. The number of parameters per reticle file (reticle parameter set) is on the order of several hundred. This number is comparatively small in comparison with the number of parameters per job.

The system file includes offset parameters that accommodate for minute errors for each exposure apparatus, and setup parameters that accommodate for hardware/software settings for each exposure apparatus. Since these parameters usually constitute information that is specific to the exposure apparatus, one system file is prepared for one exposure apparatus. Further, the number of parameters included per system file (system parameter set) is on the order of several thousand.

With the ever increasing fineness, complexity and diversity of semiconductors in recent years, there has been an explosive increase in the number of parameter sets that are required to be retained per semiconductor exposure apparatus. In addition, the number of parameters contained in each parameter set also is ever increasing. As a consequence, the time expended in parameter editing is becoming very large.

Even in a situation where a parameter to be set can be set from a set value of another parameter by calculation using a comparatively simple calculation equation, it is required that the calculation and setting be performed by human intervention or that the calculation be programmed and included in an editor program. Thus, mistakes tend to be made during these operations and an enormous amount of time is required. Further, in order to revise the set equation, program revision is necessary. This also requires a great amount of time.

Furthermore, if there is a relative relationship between parameters, the prior art is such that when a certain parameter is changed, all parameters in a relative relationship with this parameter must be re-edited.

In addition, when a parameter is changed in conformity with a characteristic specific to the exposure apparatus, it is required that the parameter file be edited.

### SUMMARY OF THE INVENTION

Accordingly, an object of the present invention is to provide an exposure apparatus that operates in accordance with a plurality of parameters, and a method of controlling the apparatus, wherein the exposure apparatus makes it possible to shorten the time needed to set the parameters.

According to a first aspect of the present invention, the foregoing object is attained by providing an exposure apparatus that operates in accordance with values of a plurality of parameters, comprising a parameter editing system having a first parameter defining unit for defining at least two parameters by a common expression.

In accordance with a preferred embodiment of the present invention, the expression includes a mathematical expression.

In accordance with a preferred embodiment of the present invention, the expression includes a conditional expression.

In accordance with a preferred embodiment of the present invention, the parameter editing system has a variable-table display unit for displaying a list of variables that can be used in the expression.

According to a second aspect of the present invention, there is provided an exposure apparatus that operates in accordance with a value of a parameter, comprising a parameter editing system having at least two parameter defining units arranged to define the value of a first parameter in a form that refers to the value of a second parameter.

In accordance with a preferred embodiment of the present invention, the parameter editing system further has a reference-parameter display unit for displaying a list of parameters that can be referred to as the second parameters.

According to a third aspect of the present invention, there is provided an exposure apparatus that operates in accordance with a plurality of parameters, comprising a parameter editing system having a parameter defining unit for defining the value of a first parameter among the plurality of parameters in a form that refers to the value of a second parameter.

In accordance with a preferred embodiment of the present invention, the parameter editing system further has a reference-parameter display unit for displaying a list of parameters that can be referred to as the second parameters.

According to a forth aspect of the present invention, there is provided a parameter editing system for editing a parameter set that includes a plurality of parameters for controlling an exposure apparatus, comprising a first parameter defining unit for defining at least two parameters by a common expression.

In accordance with a preferred embodiment of the present invention, the expression includes a mathematical expression.

In accordance with a preferred embodiment of the present invention, the expression includes a conditional expression.

In accordance with a preferred embodiment of the present invention, the system further has a variable-table display unit for displaying a list of variables that can be used in the expression.

According to a fifth aspect of the present invention, there is provided a parameter editing system for editing a parameter set that includes a parameter arranged to control an exposure apparatus, comprising at least two parameter defining units arranged to define the value of a first parameter in a form that refers to the value of a second parameter. In accordance with a preferred embodiment of the present invention, the system further has a reference-parameter display unit for displaying a list of parameters that can be referred to as the second parameters.

According to a sixth aspect of the present invention, there is provided a parameter editing system for editing a parameter set that includes a plurality of parameters for controlling an exposure apparatus, comprising a parameter defining unit for defining the value of a first parameter among the plurality of parameters in a form that refers to the value of a second parameter.

In accordance with a preferred embodiment of the present invention, the parameter editing system further has a reference-parameter display unit for displaying a list of parameters that can be referred to as the second parameters.

According to a seventh aspect of the present invention, there is provided a parameter editing method for editing a parameter set that includes a plurality of parameters for controlling an exposure apparatus, comprising a step of defining at least two parameters by a common expression.

In accordance with a preferred embodiment of the present invention, the expression includes a mathematical expression.

In accordance with a preferred embodiment of the present invention, the expression includes a conditional expression.

In accordance with a preferred embodiment of the present invention, the method further has a step of displaying a list of variables that can be used in the expression.

In accordance with a preferred embodiment of the present invention, the method further has a step of defining the value of a first parameter in a form that refers to the value of a second parameter.

According to a eighth aspect of the present invention, there is provided a parameter editing method for editing a parameter set that includes a parameter for controlling an exposure apparatus, comprising at least two steps of defining the value of a first parameter in a form that refers to the value of a second parameter.

According to a ninth aspect of the present invention, there is provided a parameter editing method for editing a parameter set that includes a plurality of parameters for controlling an exposure apparatus, comprising a step of defining the value of a first parameter among the plurality of parameters in a form that refers to the value of a second parameter.

In accordance with a preferred embodiment of the present invention, the method further has a step of displaying a list of parameters that can be referred to as the second parameters.

According to a tenth aspect of the present invention, there is provided a program for editing a parameter set that includes a plurality of parameters for controlling an exposure apparatus, the program having a step of defining at least two parameters by a common expression.

According to an eleventh aspect of the present invention, there is provided a program for editing a parameter set that includes a plurality of parameters for controlling an exposure apparatus, the program having a step of defining the value of a first parameter among the plurality of parameters in a form that refers to the value of a second parameter.

According to a twelfth aspect of the present invention, there is provided a computer-readable memory storing code of a program for editing a parameter set that includes a plurality of parameters for controlling an exposure apparatus, the program having a step of defining at least two parameters by a common expression.

According to a thirteenth aspect of the present invention, there is provided a computer-readable memory storing code of a program for editing a parameter set that includes a plurality of parameters for controlling an exposure apparatus, the program having a step of defining the value of a first parameter among the plurality of parameters in a form that refers to the value of a second parameter.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a perspective view illustrating the external appearance of a semiconductor exposure apparatus according to a preferred embodiment of the present invention;

FIG. 2 is a diagram illustrating an example of the internal structure of the semiconductor exposure apparatus shown in FIG. 1;

FIG. 3 is a block diagram illustrating the electrical circuit arrangement of the semiconductor exposure apparatus shown in FIG. 1;

FIG. 4 is a block diagram illustrating the composition of a control parameter set of a semiconductor exposure apparatus;

FIG. 5 is a diagram illustrating a layout of shots on an exposure wafer;

FIGS. 6A and 6B are schematic views of masking blades;

FIG. 7 is a diagram illustrating an example of a parameter defining unit for setting the positions of masking blades in accordance with a common expression;

FIG. 8 is a diagram illustrating a list of variables on a screen;

FIG. 9 is a diagram illustrating a list of reference parameters;

FIG. 10 is a diagram illustrating an example of masking-blade parameter settings;

FIG. 11 is a diagram illustrating an example of masking-blade parameter settings;

FIG. 12 is a diagram illustrating an example of masking-blade parameter settings;

FIGS. 13A and 13B are diagrams illustrating an example of a parameter defining unit for defining the values of job parameters in a form that refers to the value of another job parameter;

FIGS. 14A and 14B are diagrams illustrating an example of a parameter defining unit for defining the value of a job parameter in a form that refers to a system parameter;

FIG. 15 is a is a diagram illustrating the overall flow of a process for manufacturing semiconductor devices;

FIG. 16 is a diagram illustrating the detailed flow of the wafer process; and

FIG. 17 is a flowchart illustrating the flow of parameter setting and exposure processing according to a preferred embodiment of the present invention.

### DESCRIPTION OF THE PREFERRED EMBODIMENTS

An exposure apparatus according to a preferred embodiment of the present invention will now be described with reference to the accompanying drawings.

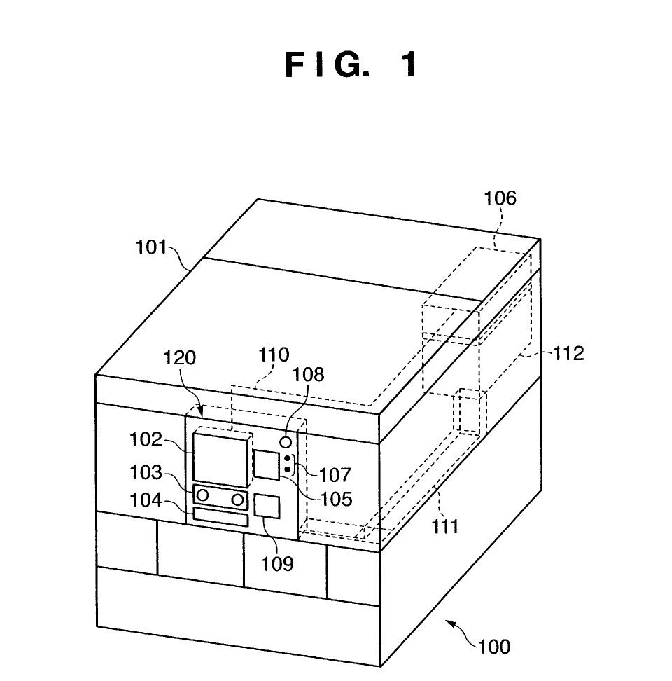

FIG. 1 is a perspective view illustrating the external appearance of a semiconductor exposure apparatus 100 according to a preferred embodiment of the present invention.

The semiconductor exposure apparatus 100 includes an exposure unit (not shown) constituted by such components and an exposure system, projection system and stage; a temperature regulating chamber 101 for controlling the environmental temperature of the overall exposure apparatus; an EWS (Engineering Work Station) 106 for controlling the overall exposure apparatus; a console 120; an exhaust duct 111 for externally venting heat produced by the console 120; and an exhaust unit 112 for exhausting the atmosphere (e.g., air) within the chamber. The console 120 has a display 102, which is controlled by the EWS 106 connected to the display 102 by a cable 110, for displaying prescribed information relating to the semiconductor exposure apparatus 100; a monitor 105 for displaying image information obtained by an image sensing unit within the semiconductor exposure apparatus 100; a control panel 103 that allows the operator to input various information to the semiconductor exposure apparatus 100; an EWS keyboard 104; an ON/OFF switch 107; an emergency stop switch 108; and various other switches 109.

A thin, flat-panel type display such as an EL, plasma or liquid crystal display is preferable as the EWS display 102. The EWS display 102 is accommodated in the front side of the chamber 101 and is connected to the EWS 106 by the cable 110. The control panel 103, keyboard 104 and monitor 105 are also placed on the front side of the chamber 101.

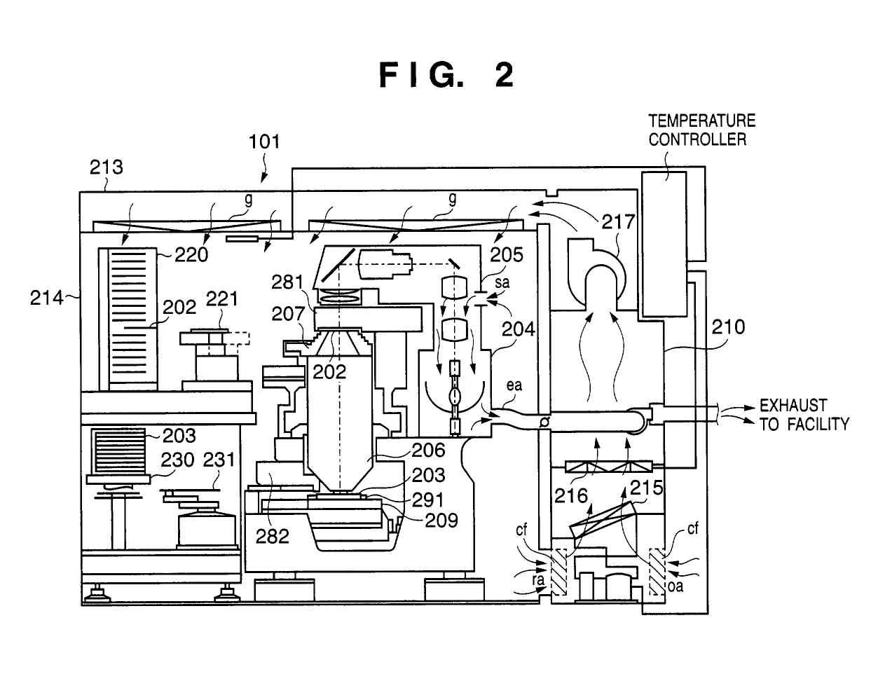

FIG. 2 is a diagram illustrating an example of the internal structure of the semiconductor exposure apparatus 100 shown in FIG. 1. FIG. 2 illustrates a stepper (step-and-repeat semiconductor exposure apparatus) as one example of the semiconductor exposure apparatus 100. Light emitted from a light-source unit 204 passes through an illuminating optical system 205 and then illuminates a reticle 202. The reticle 202 illuminated by the light has a pattern that is projected onto a photosensitive layer on a wafer 203 via a projection lens 206, whereby the pattern is transferred to the wafer 203. The reticle 202 is exposed in a state in which it is being held by suction applied by a reticle stage 207. A wafer chuck 291 is driven along each of X, Y, Z and θ axes, by way of example, by a wafer stage 209. A reticle optical system 281 for detecting the amount of positional deviation of the reticle 202 is placed above the reticle 202. An off-axis microscope 282 is disposed above the wafer stage 209 in close proximity to the projection lens 206. The off-axis microscope 282 is used mainly to detect the relative positions of an internal reference mark and an alignment mark that is on the wafer 203.

A reticle library 220 and a wafer carrier elevator 230 serving as peripheral equipment are placed in close proximity to the exposure unit proper. The required reticle and wafer are transported to the semiconductor exposure apparatus by a reticle transport unit 221 and wafer transport unit 231, respectively.

The chamber 101 comprises an air-conditioned compartment 210 for regulating the temperature of the air, a filter box 213 for capturing minute foreign matter and forming a uniform flow of cleaned air, and a booth 214 for isolating the apparatus environment from the outside. Air whose temperature has been regulated by a cooler 215 and a reheater 216 within the air-conditioned compartment 210 is supplied by a blower 217 to the interior of the booth 214 via an air filter g within the chamber 101. The air that has been supplied to the booth 214 enters the air-conditioned compartment 210 from a return port ra and circulates through the interior of the chamber 101. Strictly speaking, the chamber 101 usually is not a perfect circulatory system. In order to maintain the interior of the booth 214 at a positive pressure at all times, air that is approximately 10% of the amount of circulating air is introduced from the booth 214 via the blower from an external-air inlet oa provided in the air-conditioned compartment 210. Thus, the chamber 101 holds constant the temperature of the environment in which the semiconductor exposure apparatus is placed and maintains the air in a clean state.

The light-source unit 204 is provided with an intake port ea to prepare for cooling of a superhigh pressure mercury lamp and evolution of a harmful gas produced at the time of a laser anomaly. Some of the air in the booth 214 is forcibly exhausted to a plant facility via a special-purpose exhaust fan, which is provided in the air-conditioned compartment 210, through the light-source unit 204. Further, a chemical adsorption filter cf for eliminating chemical substances from the air is connected to the external-air inlet oa and to the return port ra.

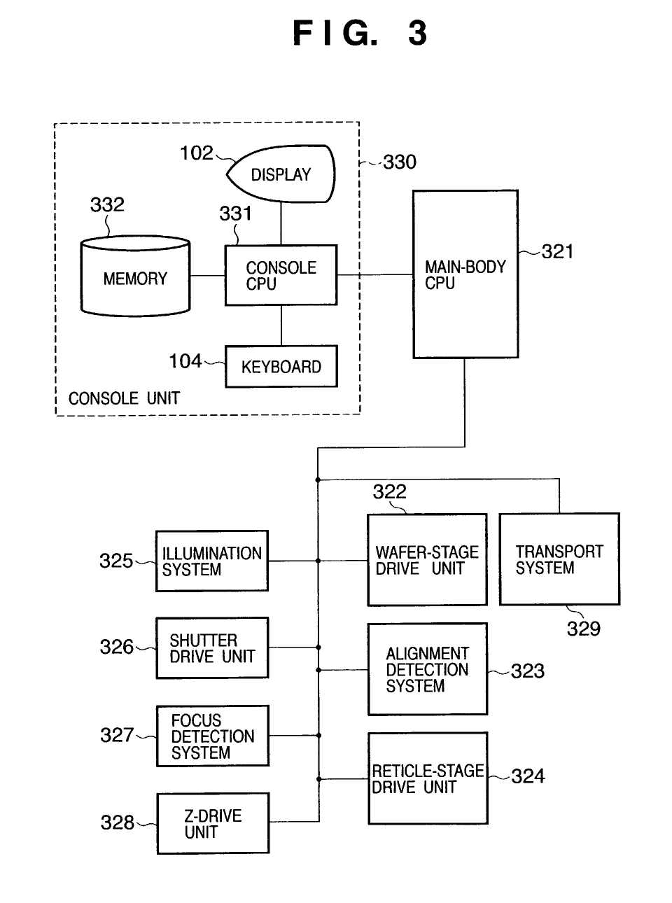

FIG. 3 is a block diagram illustrating the structure of an information processing unit applicable to the semiconductor exposure apparatus according to the preferred embodiment of the present invention.

FIG. 3 illustrates the electrical circuit arrangement of the semiconductor exposure apparatus 100 shown in FIG. 1. A CPU 321 shown in FIG. 3 is incorporated in the EWS 106, which controls the overall apparatus. The CPU 321 includes a central processor such as a microcomputer or minicomputer. The arrangement further includes a wafer-stage drive unit 322; an alignment detection system 323 that includes the off-axis microscope 282; a reticle-stage drive unit 324; an illumination system 325 that includes the light-source unit 204; a shutter drive unit 326; a focus detection system 327; and a Z-drive unit 328. These units are controlled by the CPU 321. A transport system 329 includes the reticle transport unit 221 and wafer transport unit 231, etc. A console unit 330, which has the display 102 and keyboard 104, etc., is used by the operator to apply various commands and parameters relating to the operation of the semiconductor exposure apparatus to the CPU 321. The arrangement further includes a console CPU 331 and a memory 332 for storing parameter sets, etc.

The semiconductor exposure apparatus according to this embodiment is capable of being connected to make possible communication with another semiconductor exposure apparatus or host computer, etc., via a communication interface and communication line.

A control parameter set for controlling the operation of the semiconductor exposure apparatus is capable of being input and edited by the user utilizing a user interface constituted by the EWS keyboard 104 and display 102. When necessary, the parameter set may be stored in the memory 332 or preserved in an external storage device via the communication line.

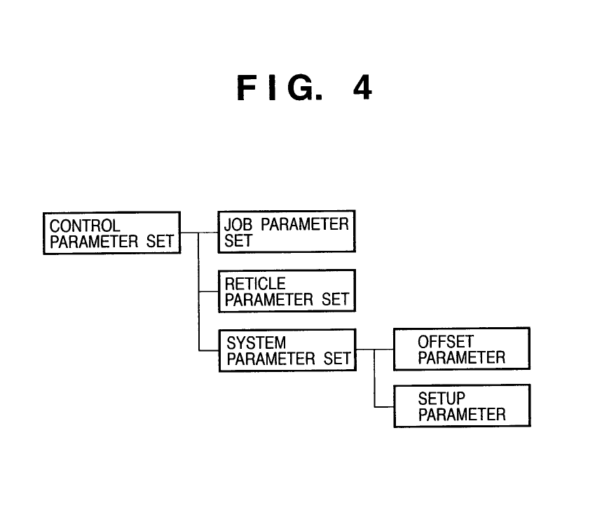

As shown in FIG. 4, there are three types of control parameter set, namely a job parameter set, reticle parameter set and system parameter set.

The job parameter set is set for each exposure process, and the reticle parameter set is set for each reticle. Accordingly, a number of job parameter sets and reticle parameter sets can exist for one exposure apparatus. On the other hand, the system parameter set is a set of parameters specific to the exposure apparatus and therefore only one set is set per exposure apparatus. A system parameter set includes offset parameters for accommodating machine error and setup parameters for changing over software/hardware settings.

A program for editing these parameter sets is referred to as an “editor” (program editing system). Utilizing the editor, the user can input and edit parameter sets using the EWS keyboard 104 and a pointing device (not shown), etc., in accordance with the names of parameters and an input guide that are displayed on the display 102 of the computer.

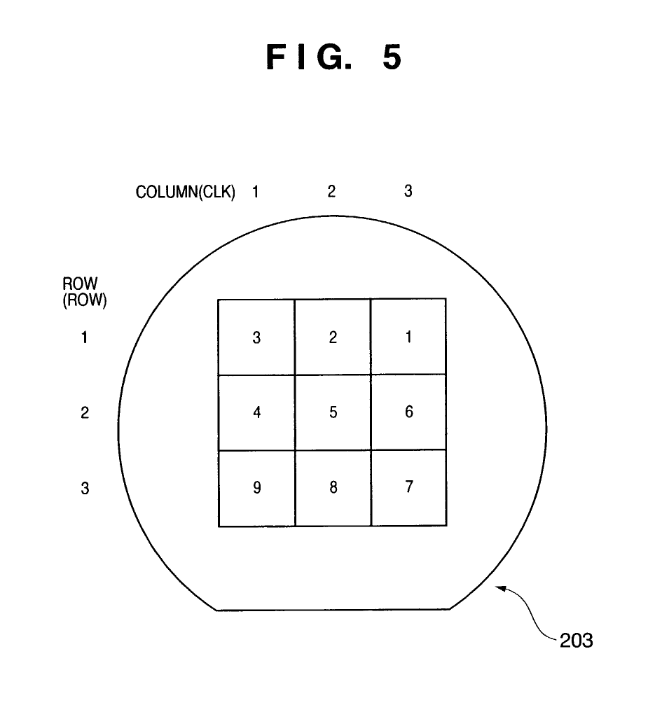

Reference will now be had to FIGS. 5, 6 and 7 to describe a method of setting the parameters of a masking blade device as one example of a method of setting parameter sets of a semiconductor exposure apparatus according to the preferred embodiment of the present invention. The present invention, however, is not limited to this example. Methods of setting other parameters are implemented in the same manner. It should be noted that this method can be implemented by supplying the CPU 321 with computer software (a program editing system).

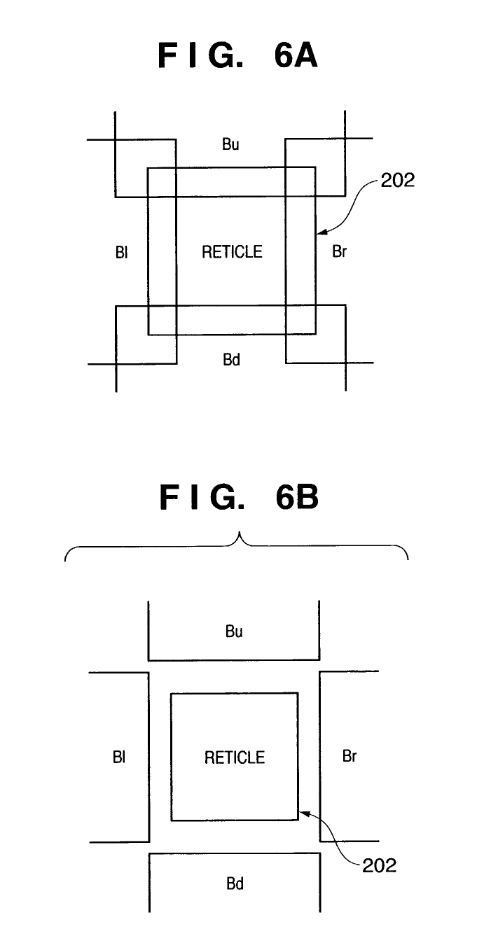

FIG. 6 is a schematic view of masking blades. The masking blades are situated in front of the reticle 202 on the optical path of the illuminating optical system 205 and block the exposing light in such a manner that the exposing light will not strike a specific area on the reticle. The masking blades are set at positions where the specific area of the reticle will not be burned by the exposing light. The blades are set at full-open positions, as shown in FIG. 6B. These positions are the default values. If it is desired to mask the specific area of the reticle 202, it is required that four blade positions Bu, Bd, Bl, Br be set as necessary. FIG. 6A illustrates a state in which four blades Bu, Bd, Bl, Br are drawn in and set in such a manner that only the central portion of the reticle will be exposed.

In a case where only a specific shot in an exposure layout is masked, the shot is specified and parameters are set in such a manner that only this shot will be masked. For example, if only a fifth shot is set in a 3×3 layout of the kind shown in FIG. 5, it will suffice to select the fifth shot using the editor and then set the four blade positions.

However, if the blade positions are changed for each shot in accordance with the order of the shots, an operation that entails calculating the blade positions shot by shot and setting the positions must be repeated by the user nine times. Though nine shots are depicted in FIG. 5, there may be several thousand shots per wafer, depending upon the shot layout, and repeating the above-mentioned operation for each of these shots would require an enormous amount of time.

A parameter editing system having a parameter defining unit that defines at least two parameters by a common expression will now be described in detail as a preferred embodiment of the present invention.

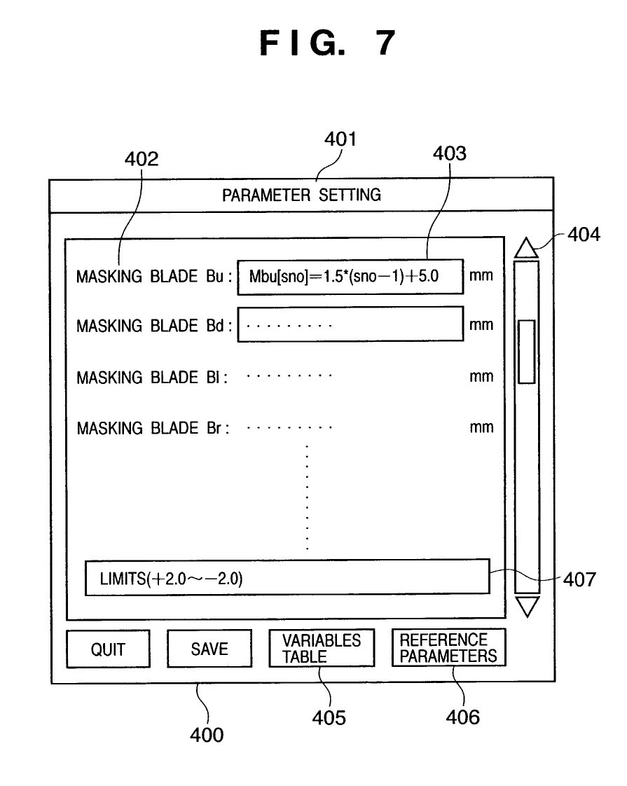

FIG. 7 is a diagram illustrating an example of a parameter defining unit for setting the positions of masking blades in accordance with a common expression.

As shown in FIG. 7, the parameter setting unit has an editing screen 400 displayed on the display 201 when the editor is launched. A title area 401 is for displaying a title that indicates the content of an operation. A parameter-name display area 402 is for displaying parameters to be set. A parameter setting area 403 is for entering and changing (editing) parameters. A scroll button 404 is for scrolling the screen when parameters cannot fit on one screen. A variable-table display button 405 serving as a variables-table display unit is for displaying a list of usable variable names and the specifics of these variables. A reference-parameter display button 406 serving as a reference-parameter display unit is for displaying and setting a list of the names of parameters to which reference can be made. A parameter-limit display area 407 is for displaying a range of values that a parameter can take on.

By using input devices such as the keyboard 104 and a pointing device (not shown), the user can input and edit parameters in the parameter setting area 403. In a case where parameters cannot fit on one screen, the user operates the scroll button 404 to display the necessary parameters on the screen and edit them if necessary.

A setting position MBu of a masking blade is set by the following common Equation (mathematical expression) (1):

Mbu[sno]=1.5*(sno−1)+5.0 (1)

where MBu is an array representing setting positions of the masking blade Bu, [ ] is a symbol representing the array, * is a symbol representing multiplication, sno is a variable representing the shot number, + is a symbol representing addition, and ( ) is a symbol representing priority of calculation. Furthermore, 1, 1.5 and 5.0 represent constants.

The variable sno is dependent upon the shot layout. The shot layout is calculated in such a manner that exposure shots will be disposed on a wafer in accordance with settings such as step size X, Y, row (row) number and column (clm) number, etc.

In the case of this example, the layout is a 3×3 layout and therefore the number of shots is nine and sno takes on values of 1 to 9. Accordingly, the array expressed by Mbu[sno] also consists of values of nine parameters from Mbu[1] to Mbu[9], and these are defined by the common Equation (1).

Equation (1) thus defined is interpreted and calculated by a program and the parameter values are set.

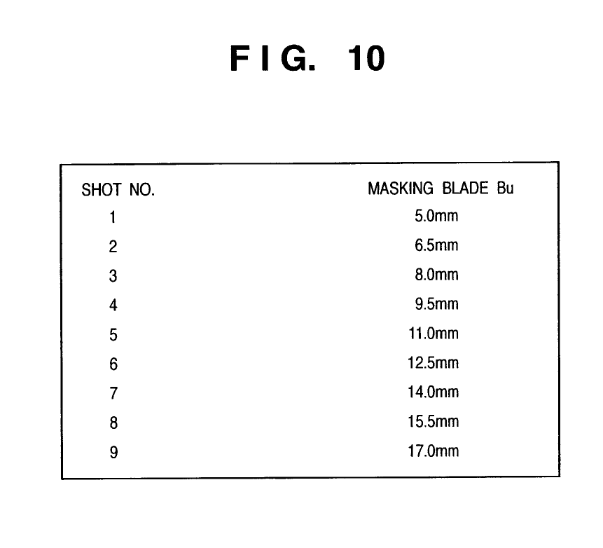

The setting of parameters by Equation (1) results in set values of the kind shown in FIG. 10 in the case of the 3×3 layout of FIG. 5.

In accordance with this method, the user is freed from the need to perform the complicated and highly time-consuming operation of previously calculating the set values of the parameters shown in FIG. 10 and repeating the parameter setting operation nine times using the above-mentioned editor. Though a nine-shot layout has been described here as an example, the present invention is not limited to this example. The time that can be saved grows as the number of shots in the layout increases.

Further, in accordance with this embodiment, it is easy to change the calculation equation. For example, in a case where it is desired to shift the position of a masking blade in the negative direction, Equation (1) need only be changed as follows:

Mbu[sno]=−1.5*(sno−1)+5.0 (2)

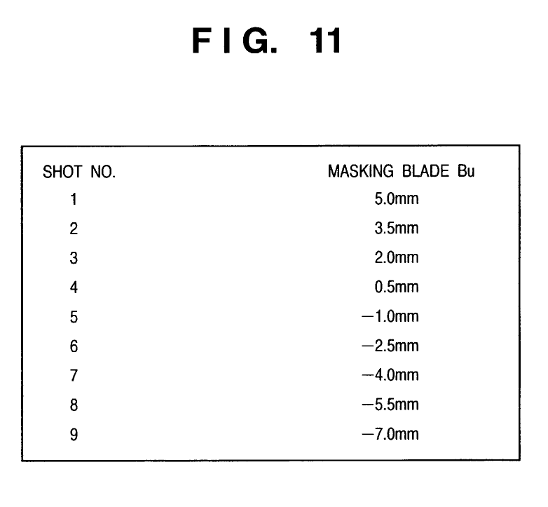

The result of interpreting and setting Equation (2) is as shown in FIG. 11.

Further, in a case where it is desired to set parameters in accordance with the column number (clm) and not in accordance with the shot number, it will suffice to set the Equation as follows:

Mbu[?,clm]=1.5*(clm−1)+5.0 (3)

where clm is a variable representing the column number (clm) of the shot layout. In this example, clm takes on the values of 1, 2 and 3.

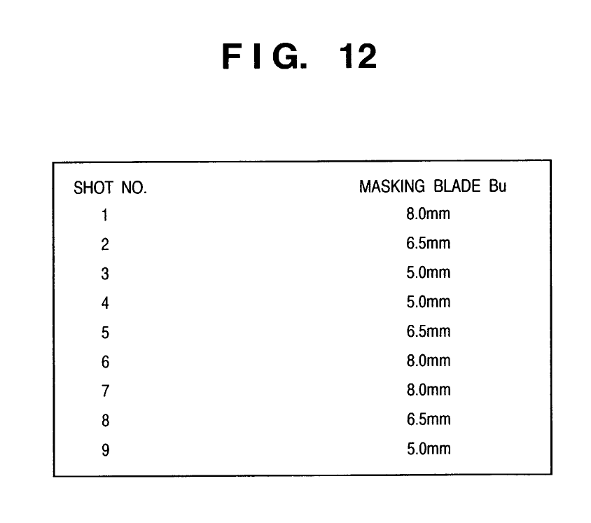

Further, Mbu[?,clm] indicates that Mbu is a two-dimensional array in which row number (row) and column number (clm) are the array elements. Here “?” indicates which of the values 1, 2 or 3 is to be taken on by a row number (row). The parameter values set by expression (3) are as shown in FIG. 12.

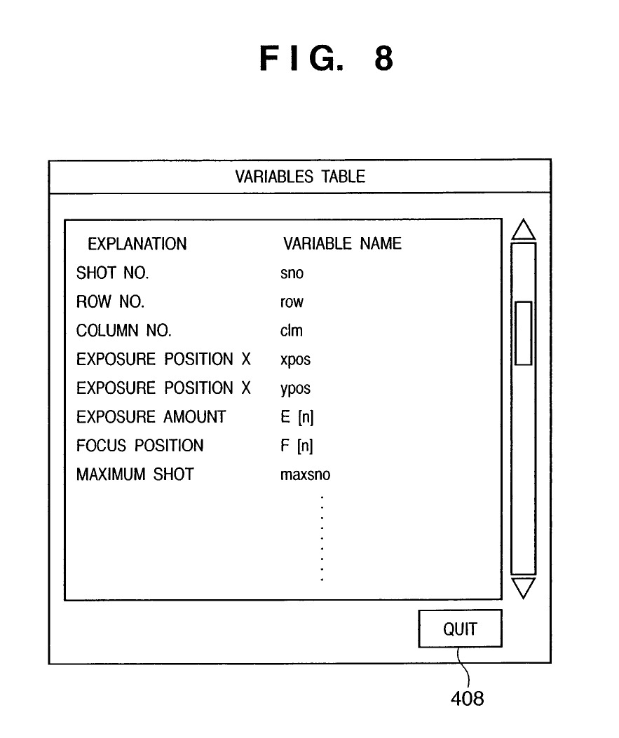

These variables (parameters) sno, row, clm can be displayed as a list by means of the variable-table display button 405 shown in FIG. 7. FIG. 8 shows an example in which these variables are displayed using the variable-table display button 405. The display is returned to the screen of FIG. 7 if a quit button 408 on this screen is clicked.

Thus, when parameters are set on the editing screen 400 of FIG. 7, variables can be set while they are displayed in list form by the variable-table shown in FIG. 8. This is advantageous in that the user need not memorize the variable names and their specifics.

One more preferred embodiment of the present invention, particularly an embodiment regarding a parameter editing system having a parameter defining unit for defining the value of a first parameter in a form that refers to the value of a second parameter, will be illustrated next.

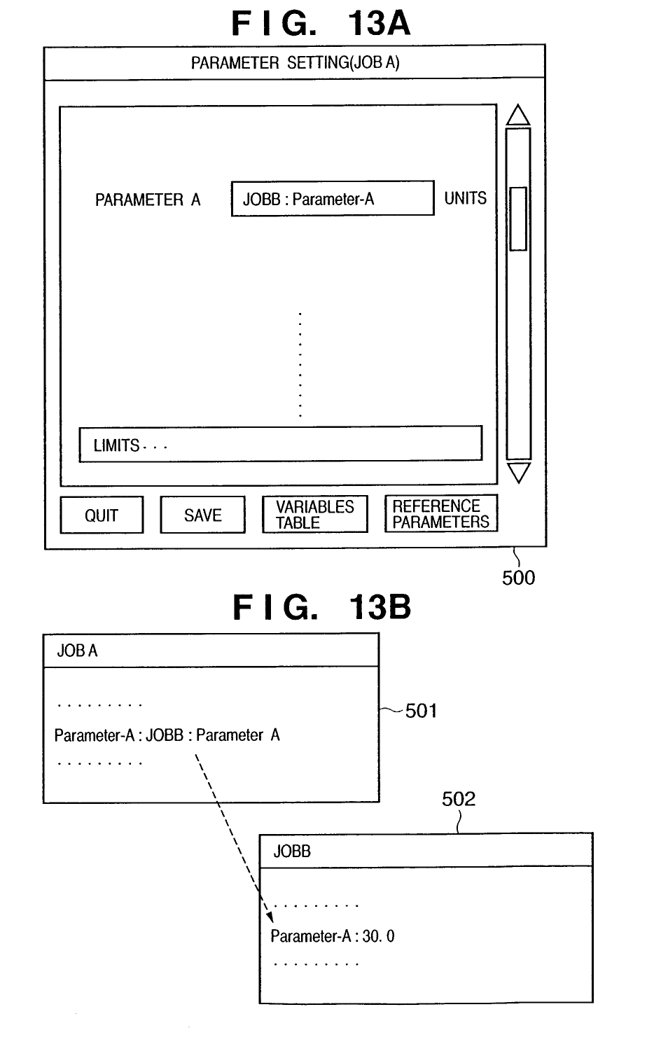

FIGS. 13A and 13B are diagrams illustrating an example of a parameter defining unit for defining the value of a job parameter A of a job A in a form that refers to the value of parameter A of another job B. The parameter defining unit has an editing screen 500 for setting parameters, as illustrated in FIG. 13A. The editing screen 500 is an editing screen similar to the editing screen 400 for setting parameters shown in FIG. 7. FIG. 13B illustrates file content 501 of job A, in which numeral 502 denotes the file content of job B. The referential relationship between the items of data is indicated schematically by the arrow connecting the file content 501 of job A and the file content 502 of job B.

The following description is displayed on the parameter-setting editing screen 500 of FIG. 13A:

JOBB: Parameter-A (4)

The description “JOBB:” indicates that Parameter-A of JOBA makes reference to “JOBB”, i.e., parameter of job B. Further, “Parameter-A” indicates that the name of the parameter is “A”, i.e., parameter A.

Here unique IDs (names) have been assigned beforehand to the descriptions of the parameter names of job such as “JOBA”, “JOBB” and “Parameter-A”. Thus, they can be easily identified.

As indicated in file content 501 of job A shown in FIG. 13B, the fact that the parameter A of job A refers to the parameter A of job B has been defined within the editor. Furthermore, “30.0” has been set as the value of parameter A of job B, as indicated in file content 502 of job B. In other words, the value of parameter A of job A is defined in a form that makes reference to the value of parameter A of job B and, as a result, the value of parameter A of job A is set to “30.0”, which is the same as the value of parameter A of job B.

By thus setting parameters based upon reference among a plurality of jobs and reticle files, an effect similar to that achieved by editing the plurality of jobs and reticle files is obtained merely by editing the value of the parameter to which reference is made.

This embodiment is such that if the setting of job B is changed, the set content that has been changed is reflected automatically in job A as well. Further, according to this embodiment, a referential relationship between two jobs is described. However, the parameter values of a greater number of jobs may be defined by reference. As a result, it is possible to shorten greatly the time consumed in the editing of job and reticle files.

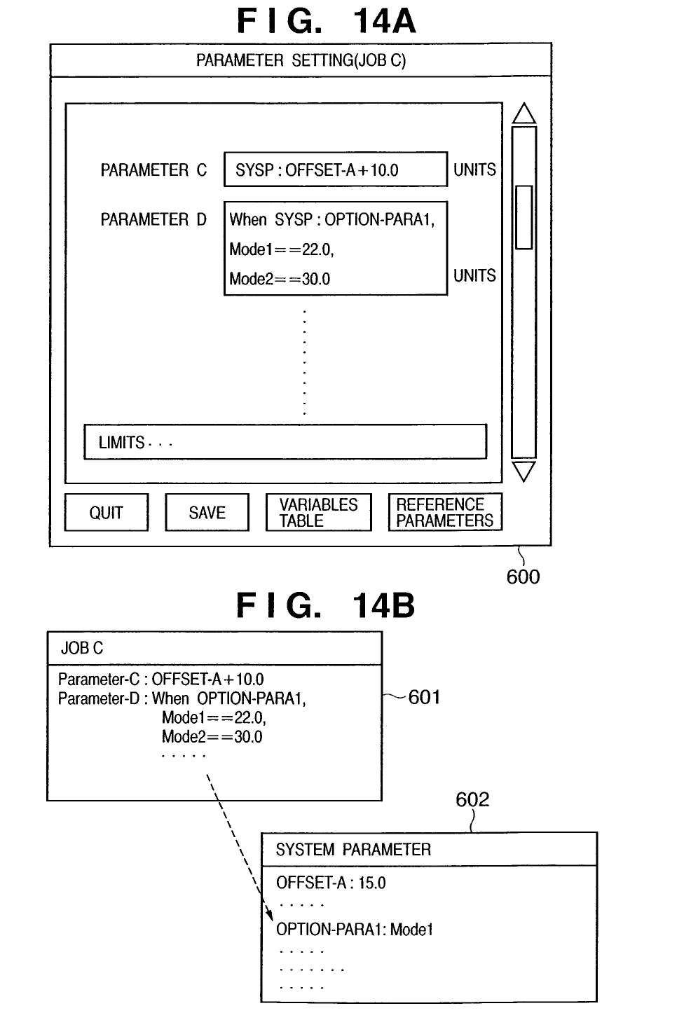

Next, an example in which the parameters of a job parameter set refer to the parameter of a system parameter set will be illustrated with reference to FIGS. 14A and 14B.

FIGS. 14A and 14B are diagrams illustrating an example of a parameter defining unit for defining the values of parameters C and D of a job C in a form that refers to a system parameter. The parameter defining unit has an editing screen 600 for setting parameters, as illustrated in FIG. 14A. The editing screen 600 is similar to the editing screen 400 for setting parameters shown in FIG. 7. FIG. 14B illustrates a description 601 of job C and a description 602 of a system parameter. The referential relationship between the items of data is indicated schematically by the arrow connecting the description 601 of job C and the description 602 of the system parameter.

The following description is displayed for parameter C on the parameter-setting editing screen 600 of FIG. 14A:

SYSP: OFFSET-A+10.0 (5)

where the description “SYSP:” indicates the fact that reference is made to the system parameter. Further, “OFFSET-A” indicates a system offset parameter whose name is “A”, i.e., offset A.

As indicated in description 601 of job C shown in FIG. 14B, the fact that the parameter C of job C refers to offset A of the system parameters has been defined within the editor.

Furthermore, the value “15.0” has been set as parameter A, as indicated in description 602 of the system parameter. In other words, parameter C of job C has been defined in a form that refers to a value obtained by adding 10.0 to the offset A of the system parameters. As a result, parameter C of job C is set to “25.0”.

Further, the following description is displayed for parameter D on the parameter-setting editing screen 600 of FIG. 14A:

When SYSP: OPTION-PARA1,

“Mode1”==22.0,

“Mode2”==30.0 (6)

where the description “SYSP:” indicates the fact that reference is made to the system parameter. Further, “OPTION-PARA1” indicates a system offset parameter whose name is “PARA-1”, i.e., option parameter −1.

In this embodiment, option parameter −1 is a parameter that takes on a value of “Mode1” or “Mode2”.

The description “When” forms a pair with the description “==” and represents a conditional branch to the effect that 22.0 is set to parameter D if the option parameter −1 is Mode1 and 30.0 is set to parameter D if the option parameter −1 is Mode2.

The conditional expression involving parameter D is defined in the editor, as indicated in description 601 of job C. The parameter D is set by this condition after reference is made to option parameter −1 of the system parameters. In this example, Mode1 has been set to option parameter −1, as indicated by description 602 of the system parameter. In other words, parameter D of job C is the same as that for which “22.0” has been set owing to the condition branch, and parameter D of job C is set to “22.0”.

Thus, by defining a parameter in a form that makes reference between a job and/or reticle file and a system file, it is no longer necessary to change offset values specific to the semiconductor exposure apparatus or parameter values in accordance with setup parameters. In other words, in this embodiment, if job C is copied and used in an exposure apparatus in which a job has not yet been created, parameter values of a job and/or reticle file are set automatically by referring to the system parameters of the exposure apparatus. As a result, the user need not check the system parameters one by one and re-edit job and/or reticle files, thus making it possible to shorten editing time greatly. Further, since setting by a human being is not carried out, human editing errors do not occur and the safety of the apparatus is enhanced.

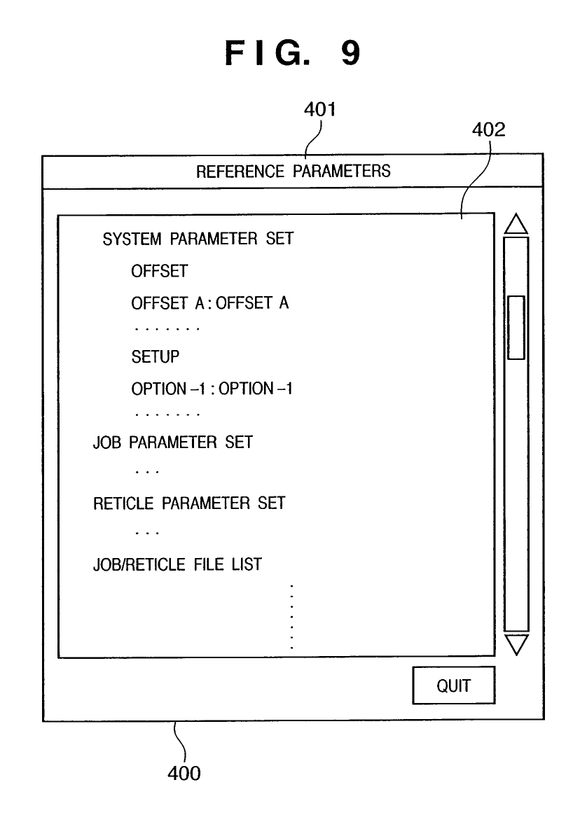

FIG. 9 is a diagram illustrating a list of reference parameters.

When the reference-parameter display button 406 in FIG. 7 is clicked, an editing screen 400 of the kind shown in FIG. 9 is displayed. A title indicating the content of an operation is displayed in the title area 401 of FIG. 9, and a list of offset parameters and setup parameters in a system parameter set, a job parameter set, a reticle parameter set and job and reticle files, etc., is displayed in the parameter-name display area 402.

A unique name to which reference can be made can be referred to and set by making it possible to display a list of parameters. Accordingly, it is unnecessary for a user to memorize the names of parameters.

In another preferred embodiment of the present invention, it is preferred that this system be applied to the setting of amount of exposure and focus offset.

Generally, in order to decide the optimum values of amount of exposure and focus offset, it is necessary to search for the optimum value by changing the set values of amount of exposure and focus shot by shot.

With this embodiment, the optimum values can be found by performing exposure upon changing the amount of exposure in the column direction and the focus offset in the row direction using Equation (7) below with regard to a layout of the kind shown in FIG. 5, by way of example.

FOFS[?,clm]=1.5*(clm−1)+50 (7)

Further, as for the setting of alignment offsets such as orthogonality and magnification, past set values may be stored as variables and the conditions for pilot wafer may be set based upon a mean value of these past set values.

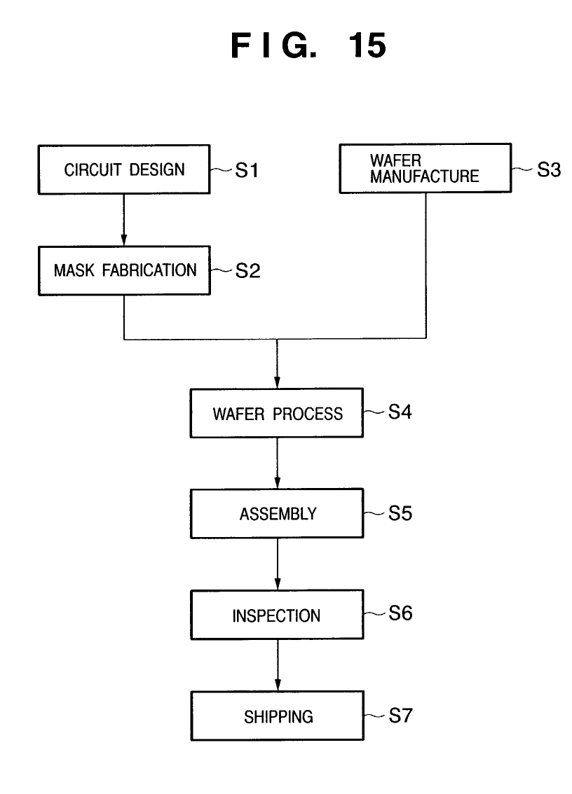

A process for manufacturing a semiconductor device utilizing the exposure apparatus set forth above will now be described. FIG. 15 illustrates the overall flow of a process for manufacturing semiconductor devices. The circuit for the semiconductor device is designed at step 1 (circuit design). A mask is fabricated at step 2 (mask fabrication) based upon the circuit pattern designed. Meanwhile, a wafer is manufactured using a material such as silicon at step 3 (wafer manufacture). The actual circuit is formed on the wafer by lithography, using the mask and wafer that have been prepared, at step 4 (wafer process), which is also referred to as “pre-treatment”. A semiconductor chip is obtained, using the wafer fabricated at step 4, at step 5 (assembly), which is also referred to as “post-treatment”. This step includes assembly steps such as actual assembly (dicing and bonding) and packaging (chip encapsulation). The semiconductor device fabricated at step 5 is subjected to inspections such as an operation verification test and durability test at step 6 (inspection). The semiconductor device is completed through these steps and then is shipped (step 7).

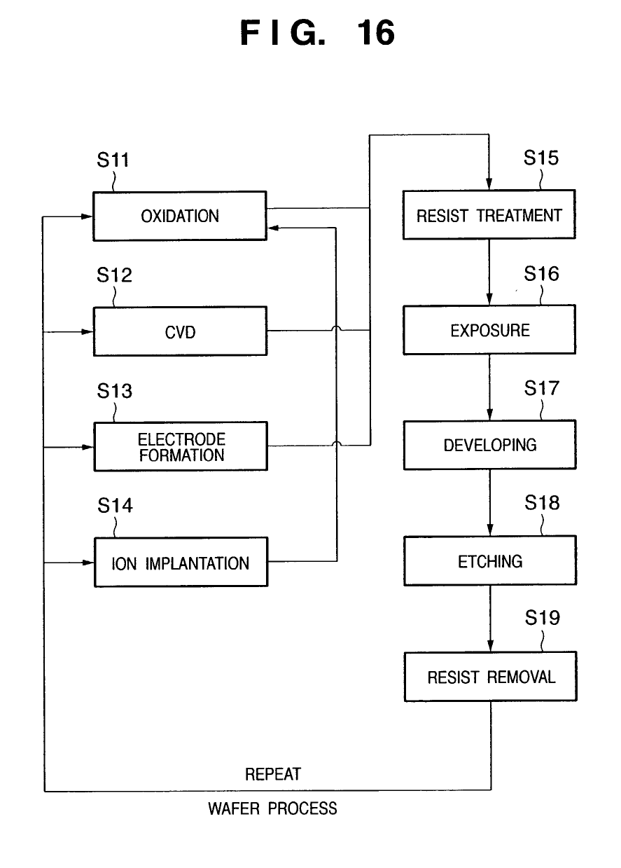

FIG. 16 is a flowchart illustrating the detailed flow of the wafer process mentioned above. The surface of the wafer is oxidized at step 11 (oxidation). An insulating film is formed on the wafer surface at step 12 (CVD), electrodes are formed on the wafer by vapor deposition at step 13 (electrode formation), and ions are implanted in the wafer at step 14 (ion implantation). The wafer is coated with a photoresist at step 15 (resist treatment) and the circuit pattern is transferred to the wafer by the above-described exposure apparatus at step 16 (exposure). The exposed wafer is developed at step 17 (development). Portions other than the developed photoresist image are etched away at step 18 (etching), and unnecessary resist left after etching is performed is removed at step 19 (resist removal). Multiple circuit patterns are formed on the wafer by implementing these steps repeatedly.

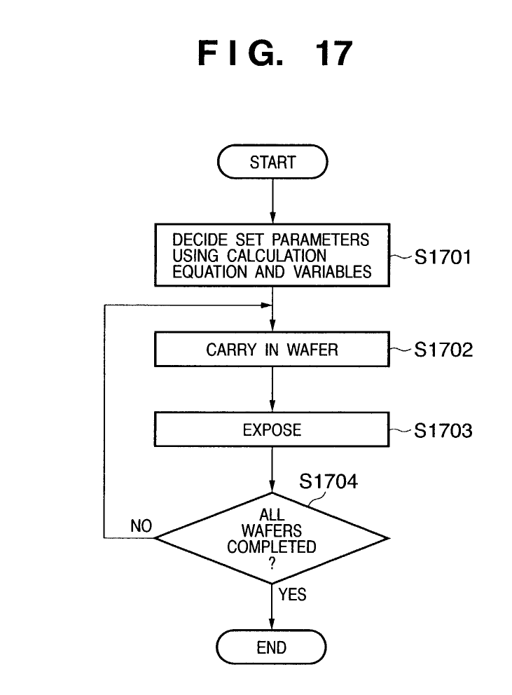

FIG. 17 is a flowchart illustrating the flow of parameter setting and exposure processing according to a preferred embodiment of the present invention.

A control parameter set that employs a common expression is set using the editor at step S1701. At least two parameters among a plurality of parameters included in the control parameter set are set using the common expression. Further, parameter values can also be defined in a form that refers to another job.

The wafer 203 is transported to the exposure apparatus by the wafer transport unit 231 at step S1702. The wafer 203 that has been transported to the exposure apparatus is secured to the wafer stage 209 by suction applied by the wafer chuck 291.

The wafer set at step S1702 is exposed at step S1703 in accordance with the set values of the various parameters set at step S1701.

It is determined at step S1704 whether the processing of all wafers has been completed. If processing has not been completed, then steps S1701 to S1704 are repeated successively with regard to wafers remaining to be processed. If wafers to be processed no longer remain, then this series of processing is exited and the exposure apparatus is halted.

In accordance with the present invention, it is possible to provide an exposure apparatus that operates in accordance with a plurality of parameter values, and a method of controlling this apparatus, wherein the exposure apparatus makes it possible to shorten the time needed to set the parameters.

As many apparently widely different embodiments of the present invention can be made without departing from the spirit and scope thereof, it is to be understood that the invention is not limited to the specific embodiments thereof except as defined in the appended claims.

What is claimed is:

1. An exposure apparatus that operates in accordance with values of a plurality of parameters, comprising a parameter editing system having a first parameter defining unit for defining at least two parameters by a common expression.

2. The apparatus according to claim 1, wherein the expression includes a mathematical expression.

3. The apparatus according to claim 1, wherein the expression includes a conditional expression.

4. The apparatus according to claim 1, wherein said parameter editing system has a variable-table display unit arranged to display a list of variables that can be used in the expression.

5. An exposure apparatus that operates in accordance with a value of a parameter, comprising a parameter editing system having at least two parameter defining units arranged to define the value of a first parameter in a form that refers to the value of a second parameter.

6. The apparatus according to claim 5, wherein said parameter editing system further has a reference-parameter display unit arranged to display a list of parameters that can be referred to as the second parameters.

7. An exposure apparatus that operates in accordance with values of a plurality of parameters, comprising a parameter editing system having a parameter defining unit arranged to define the value of a first parameter among the plurality of parameters in a form that refers to the value of a second parameter.

8. The apparatus according to claim 7, wherein said parameter editing system further has a reference-parameter display unit arranged to display a list of parameters that can be referred to as the second parameters.

9. A parameter editing system for editing a parameter set that includes a plurality of parameters arranged to control an exposure apparatus, comprising a first parameter defining unit arranged to define at least two parameters by a common expression.

10. The system according to claim 9, wherein the expression includes a mathematical expression.

11. The system according to claim 9, wherein the expression includes a conditional expression.

12. The system according to claim 9, further comprising a variable-table display unit arranged to display a list of variables that can be used in the expression.

13. A parameter editing system for editing a parameter set that includes a parameter arranged to control an exposure apparatus, comprising at least two parameter defining units arranged to define the value of a first parameter in a form that refers to the value of a second parameter.

14. The system according to claim 13, further comprising a reference-parameter display unit arranged to display a list of parameters that can be referred to as the second parameters.

15. A parameter editing system for editing a parameter set that includes a plurality of parameters for controlling an exposure apparatus, comprising a parameter defining unit arranged to define the value of a first parameter among the plurality of parameters in a form that refers to the value of a second parameter.

16. The system according to claim 15, further comprising a reference-parameter display unit arranged to display a list of parameters that can be referred to as the second parameters.

17. A parameter editing method for editing a parameter set that includes a plurality of parameters for controlling an exposure apparatus, comprising a step of defining at least two parameters by a common expression.

18. The method according to claim 17, wherein the expression includes a mathematical expression.

19. The method according to claim 17, wherein the expression includes a conditional expression.

20. The method according to claim 17, further comprising a step of displaying a list of variables that can be used in the expression.

21. A parameter editing method for editing a parameter set that includes a parameter for controlling an exposure apparatus, comprising at least two steps of defining the value of a first parameter in a form that refers to the value of a second parameter.

22. The method according to claim 21, further comprising a step of displaying a list of parameters that can be referred to as the second parameters.

23. A parameter editing method for editing a parameter set that includes a plurality of parameters for controlling an exposure apparatus, comprising a step of defining the value of a first parameter among the plurality of parameters in a form that refers to the value of a second parameter.

24. The method according to claim 23, further comprising a step of displaying a list of parameters that can be referred to as the second parameters.

25. A program for editing a parameter set that includes a plurality of parameters for controlling an exposure apparatus, said program having a step of defining at least two parameters by a common expression.

26. A program for editing a parameter set that includes a plurality of parameters for controlling an exposure apparatus, said program having a step of defining the value of a first parameter among the plurality of parameters in a form that refers to the value of a second parameter.

27. A computer-readable memory storing code of a program for editing a parameter set that includes a plurality of parameters for controlling an exposure apparatus, said program having a step of defining at least two parameters by a common expression.

28. A computer-readable memory storing code of a program for editing a parameter set that includes a plurality of parameters for controlling an exposure apparatus, said program having a step of defining the value of a first parameter among the plurality of parameters in a form that refers to the value of a second parameter.
